(19) United States
(12) Patent Application Publication
(10) Pub. No.: US 2010/0302451 A1
(43) Pub. Date: Dec. 2, 2010

(54) VIDEO SIGNAL PROCESSING DEVICE

(75) Inventor: Yuichi Ishikawa, Hyogo (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/744,850

(22) PCT Filed: Dec. 2, 2008
(86) PCT No.: PCT/JP2008/003567

§ 371 Date: May 26, 2010

(30) Foreign Application Priority Data
Dec. 4, 2007 (JP) 2007-313780

(51) Int. Cl. H04N 5/14

(52) U.S. Cl. 348/699; 348/E05.062

(57) ABSTRACT

A motion vector can be accurately detected in a video signal processing device that performs video signal processing with use of a plurality of processors. The video signal processing device includes motion vector detection units (121a, 121b) that detect motion vectors from an input video signal; a vector memory (122a, 122b) that stores information indicating the detected motion vectors; frame interpolation processing circuits (123a, 123b) that process video signals, the input video signal being divided into n (n being an integer greater than or equal to 2) regions, and processing of video signals corresponding to the regions being divided among the frame interpolation processing circuits (123a, 123b) and performed with use of the motion vector information stored in the vector memory (122a, 122b); and a screen synthesis unit (13) that generates an output video signal by synthesizing the processing results of the frame interpolation processing circuits (123a, 123b). The motion vector detection units (121a, 121b) detect motion vectors with respect to regions that include regions obtained by completely dividing the input video signal into two regions, and are larger than the obtained regions.

### TECHNICAL FIELD

The present invention relates to a video signal processing device that processes a video signal, and in particular to a video signal processing device that performs various types of signal processing with the use of motion vectors.

### BACKGROUND ART

In recent years, the digitization of audio/video information has been progressing, and devices that can digitize and work with video signals are becoming widely prevalent. Since video signals have an enormous amount of information, such devices generally reduce the amount of information when performing encoding, taking into consideration recording capacity and transmission efficiency. International standards such as MPEG (Moving Picture Experts Group) are used widely as technology for encoding video signals.

Also, the encoding of video signals requires an enormous amount of calculation, and a moving image processing device is known in which, with the goal of speeding up encoding processing, input video data is, for example, divided into a plurality of regions, and the processing of the divided regions is divided among a plurality of processors (e.g., see Japanese Patent No. 2918601). In this way, a screen is divided into a plurality of regions and processed by a plurality of processors, and therefore the load borne by each processor is lightened, and processing is performed faster.

The following describes frame interpolation processing in a conventional moving image processing device with reference to the drawings. FIG. 8 is an illustrative diagram illustrating frame interpolation processing that makes use of motion vectors. As shown in FIG. 8, interframe interpolated images P_{SUP1}, P_{SUP2}, and so on are created from two consecutive frames among input images P_{IN1}, P_{IN2}, P_{IN3} and so on, and are inserted. In this case, motion vectors V₁, V₂, and so on in the interpolated images are generated from input images before/after the interpolated images. Accordingly, if the input video is input at, for example, 60 Hz, video can be output at 60 Hz or more (e.g., 90 Hz or 120 Hz).

FIG. 9 is a block diagram of a conventional video signal processing device that realizes frame interpolation that makes use of motion vectors, in which an input video is divided into a plurality of regions (in FIG. 9, two regions), and the processing of the regions is divided among a plurality of processors, as disclosed in the aforementioned Japanese Patent No. 2918601 and the like. The configuration shown in FIG. 9 includes a screen division unit 91 that divides an input video into two regions (e.g., the left half and right half of the screen), a processor 92a that receives an input of and processes a video signal corresponding to the left half of the screen, a processor 92b that receives an input of and processes a video signal corresponding to the right half of the screen, and a screen synthesis unit 93 that generates a video signal corresponding to the entire screen by synthesizing the processing results of the processors 92a and 92b.

The processor 92a includes a motion vector detection unit 921a that detects a motion vector from the video signal corresponding to the left half of the screen, a vector memory 922a that stores information indicating the detected motion vector, and a frame interpolation processing unit 923a that generates an interpolated video signal corresponding to the left half of the screen based on the motion vector information stored in the vector memory 922a and the input video signal corresponding to the left half of the screen. Also, the processor 92b includes a motion vector detection unit 921b that detects a motion vector from the video signal corresponding to the right half of the screen, a vector memory 922b that stores information indicating the detected motion vector, and a frame interpolation processing unit 923b that generates an interpolated video signal corresponding to the right half of the screen based on the motion vector information stored in the vector memory 922b and the input video signal corresponding to the right half of the screen.

### DISCLOSURE OF INVENTION

### Problem to be Solved by the Invention

However, problems such as the following occur when detecting motion vectors in a conventional moving image processing device in which the processing of a plurality of divided regions is divided among a plurality of processors such as disclosed in the aforementioned Japanese Patent No. 2918601.

The following description takes the example of a video containing an object 96 that moves so as to cross a screen 95, as shown in FIG. 10. In FIG. 10, the screen 95 is divided into a left-half region 95a and a right-half region 95b by a boundary line 95c, the video signal corresponding to the left-half region 95a is processed by the processor 92a, and the video signal corresponding to the right-half region 95b is processed by the processor 92b. In this case, if the object 96 appears in the left-half region 95a in one frame (a first frame), and then the object 96 moves to the right-half region 95b in the next frame (a second frame) as shown in FIG. 10, neither of the processors 92a and 92b can detect the motion vector of the object 96. Accordingly, in such a case, there is the issue that appropriate frame interpolation processing based on motion vectors and the like cannot be performed in the conventional moving image processing device.

In light of the aforementioned issues, an object of the present invention is to enable accurate detection of motion vectors in a video signal processing device that performs video signal processing with use of a plurality of processors.

### Means for Solving Problem

In order to achieve the aforementioned object, a video signal processing device according to the present invention includes: a motion vector detection unit that detects a motion vector from an input video signal; a vector memory that stores information indicating the motion vector detected by the motion vector detection unit; a plurality of signal processing units that each process a video signal, the input video signal being divided into n (n being an integer greater than or equal to 2) regions, and processing of video signals corresponding to the regions being divided among the plurality of signal processing units and performed with use of the motion vector information stored in the vector memory; and a synthesis processing unit that generates an output video signal by synthesizing processing results of the plurality of signal processing units, wherein the motion vector detection unit detects a motion vector with respect to regions that include regions obtained by evenly dividing the input video signal into n regions, and are larger than the obtained regions.

According to this configuration, in the video signal processing device in which the processing of n divided regions of the input video signal is divided among the plurality of signal processing units, the motion vector detection unit detects a motion vector with respect to regions that include regions obtained by evenly dividing the input video signal into n regions, and are larger than the obtained regions. Specifically, the regions that are the target of motion vector detection are larger than regions obtained by equally dividing the input video signal into n regions, and therefore even in the case where the input video signal contains a video of an object that moves across the boundary between regions that are the target of the processing performed by the signal processing units, there is a higher possibility that the motion vector of the object can be detected. This enables providing a video signal processing device that can detect motion vectors accurately.

In the video signal processing device according to the present invention, it is preferable that the motion vector detection unit includes a first motion vector detection unit that detects a motion vector with respect to one of two regions that each have an overlapping part in a horizontal or vertical center portion of the input video signal, and a second motion vector detection unit that detects a motion vector with respect to the other of the two regions. Furthermore, in this video signal processing device, it is preferable that in generating an output video signal corresponding to the overlapping parts of the two regions in the input video signal, the synthesis processing unit determines which of the processing results of the plurality of signal processing units is to be used, according to a pointing direction of a horizontal or vertical component of the motion vector.

In the video signal processing device according to the present invention, it is preferable that the motion vector detection unit detects a motion vector with respect to the entirety of the input video signal.

### EFFECTS OF THE INVENTION

According to the present invention, it is possible to accurately detect motion vectors in a video signal processing device that performs video signal processing with use of a plurality of processors.

### BRIEF DESCRIPTION OF DRAWINGS

FIG. 1 is a block diagram showing the schematic configuration of a video signal processing device according to Embodiment 1 of the present invention.

FIGS. 2A and 2B are illustrative diagrams showing a screen dividing method performed by a screen division unit in Embodiment 1.

FIG. 3A is an illustrative diagram showing an example of a video containing an object that moves so as to cross the screen, FIG. 3B is an illustrative diagram showing a motion vector obtained in a right-side region, and FIG. 3C is an illustrative diagram showing a motion vector obtained in a left-side region

FIG. 4 is a circuit diagram showing a concrete example of a case in which the video signal processing device shown in FIG. 1 is configured by two semiconductor chips.

FIG. 5 is a block diagram showing the schematic configuration of a video signal processing device according to Embodiment 2 of the present invention.

FIG. 6 is an illustrative diagram showing a screen dividing method performed by a screen division unit in Embodiment 2.

FIG. 7 is a circuit diagram showing a concrete example of a case in which the video signal processing device shown in FIG. 5 is configured by two semiconductor chips.

FIG. 8 is an illustrative diagram illustrating frame interpolation processing that makes use of motion vectors.

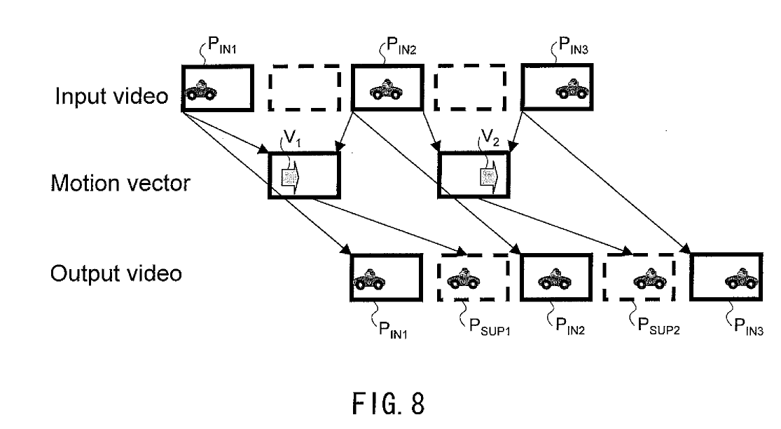

FIG. 9 is a block diagram showing the configuration of a conventional video signal processing device in which an input video is divided into a plurality of regions, and the processing of the regions is divided among a plurality of processors.

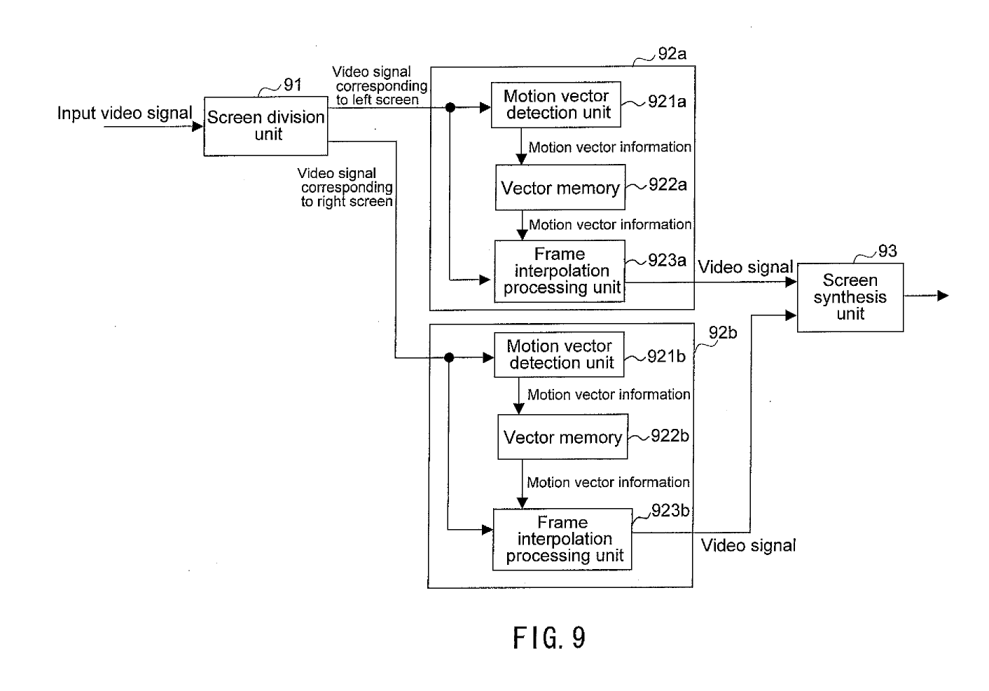

FIG. 10 is an illustrative diagram showing an example of a video containing an object that moves so as to cross the screen.

### DESCRIPTION OF THE INVENTION

### Embodiment 1

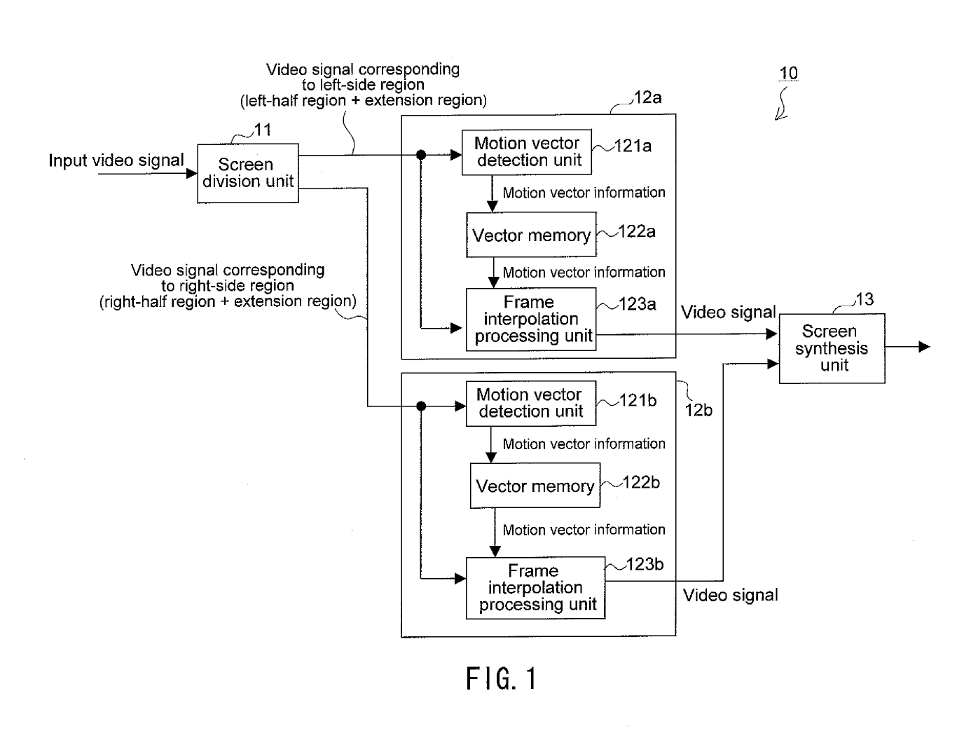

A description will be given of a video signal processing device according to Embodiment 1 of the present invention with reference to FIGS. 1 to 4. FIG. 1 is a block diagram showing the schematic configuration of the video signal processing device according to Embodiment 1 of the present invention. As shown in FIG. 1, a video signal processing device 10 according to the present embodiment includes a screen division unit 11 that divides an input video, processors 12a and 12b that process video signals received from the screen division unit 11, and a screen synthesis unit 13 (synthesis processing unit) that synthesizes the processing results of the processors 12a and 12b.

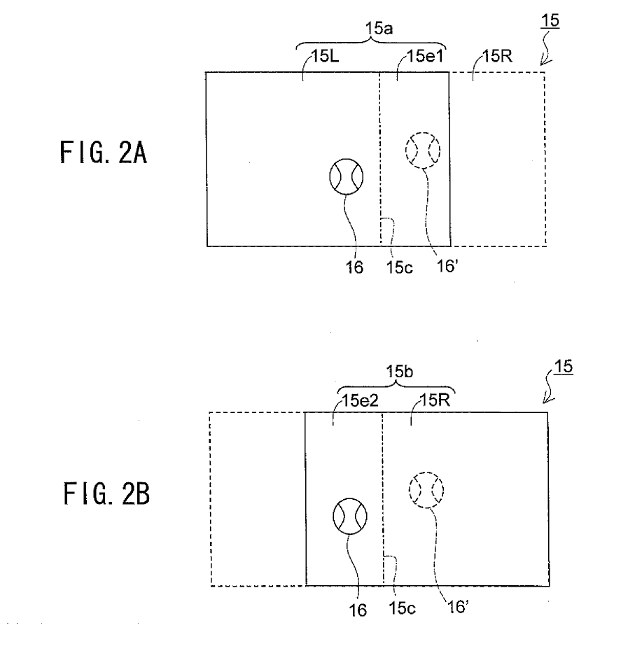

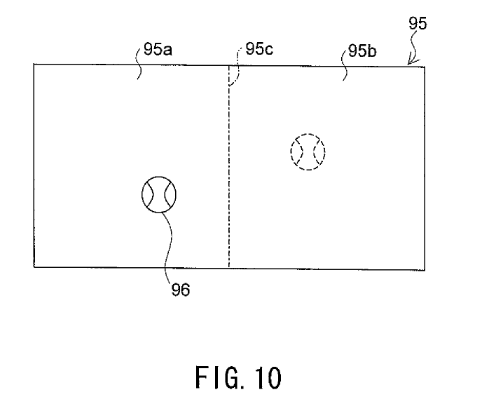

FIG. 2 is an illustrative diagram showing a screen dividing method performed by the screen division unit 11 of the present embodiment. In the present embodiment, a video signal corresponding to a full screen 15 is divided into a left-side region 15a shown by solid lines in FIG. 2A and a right-side region 15b shown by solid lines in FIG. 2B. Note that a dashed-dotted line 15c shown in FIGS. 2A to 2B is a center line with respect to the horizontal direction in the full screen 15. Specifically, instead of completely dividing the screen into halves as with the screen dividing method in the conventional video signal processing device (see FIG. 10), the screen division unit 11 divides the screen such that the left-side region 15a and the right-side region 15b have regions of overlap with each other in the center portion of the screen. In other words, the left-side region 15a includes a left-half region 15L of the screen and an extension region 15e₁. The extension region 15e₁ is a portion of a right-half region 15R that is adjacent to the left-half region 15L. The right-side region 15b includes the right-half region 15R of the screen and an extension region 15e₂. The extension region 15e₂ is a portion of the left-half region 15L that is adjacent to the right-half region 15R. Accordingly, the extension regions 15e₁ and 15e₂ are regions of overlap that are included in both the left-side region 15a and the right-side region 15b.

The processor 12a receives an input of a video signal corresponding to the left-side region 15a from the screen division unit 11, and performs frame interpolation processing with respect to the left-side region 15a. The processor 12b receives an input of a video signal corresponding to the right-side region 15b from the screen division unit 11, and performs frame interpolation processing with respect to the right-side region 15b. The screen synthesis unit 13 generates a video signal corresponding to the entire screen by synthesizing the processing results of the processors 12a and 12b.

The processor 12a includes a motion vector detection unit 121a that detects a motion vector from the video signal corresponding to the left-side region 15a, a vector memory 122a that stores information indicating the detected motion vector, and a frame interpolation processing unit 123a (signal processing unit) that generates an interpolated video signal corresponding to the left-side region 15a based on the motion vector information stored in the vector memory 122a and the input video signal corresponding to the left-side region 15a.

The motion vector detection unit 121a has a frame memory (not shown) that stores at least two frames of the video signal corresponding to the left-side region 15a, and detects a motion vector between consecutive frames from the video signal corresponding to the left-side region 15a. Although a detailed description of the motion vector detection method has been omitted since such methods are well-known, it is possible to employ a method of dividing a video signal into blocks of a predetermined size and performing block matching between frames, as well as a method of performing matching in units of pixels. The frame interpolation processing unit 123a extracts the detected motion vector information from the vector memory 122a, and generates an interframe interpolated video signal with use of the video signal stored in the frame memory. A detailed description of the processing for generating an interpolated video signal with use of motion vectors has been omitted since such processing is also well-known.

On the other hand, the processor 12b includes a motion vector detection unit 121b that detects a motion vector from the video signal corresponding to the right-side region 15b, a vector memory 122b that stores information indicating the detected motion vector, and a frame interpolation processing unit 123b that generates an interpolated video signal corresponding to the right-side region 15b based on the motion vector information stored in the vector memory 122b and the input video signal corresponding to the right-side region 15b. The processing content of the processor 12b is the same as that of the processor 12a, except for the difference of whether the video signal targeted for processing corresponds to the left-side region 15a or the right-side region 15b.

The following describes processing performed by the video signal processing device according to the configuration shown in FIG. 1, with reference to FIG. 2. Note that in FIG. 2, an object 16 moves so as to cross the full screen 15, the object 16 appears in the left-half region 15L of the full screen 15 in one frame (a first frame), and the object 16 appears in the right-half region 15R in the next frame (a second frame) as indicated by reference numeral 16′ in FIG. 2. Note that as shown in FIG. 2A, it can be seen that the left-side region 15a contains an image of both the object 16 in the first frame and the object 16′ in the second frame. As shown in FIG. 2B, it can also be seen that the right-side region 15b includes an image of both the object 16 in the first frame and the object 16′ in the second frame. Accordingly, after receiving an input of the video signal corresponding to the left-side region 15a, the processor 12a can obtain a motion vector from the object 16 to the object 16′ by performing block matching on the video signal of the first frame and the video signal of the second frame in the left-side region 15a. Likewise, after receiving an input of the video signal corresponding to the right-side region 15b, the processor 12b can obtain a motion vector from the object 16 to the object 16′ by performing block matching on the video signal of the first frame and the video signal of the second frame in the right-side region 15b.

Also, based on the video signal corresponding to the left-side region 15a, the processor 12a can also detect a motion vector of an object moving within the left-half region 15L between frames, and an object moving between the left-half region 15L and the extension region 15e₁. Likewise, based on the video signal corresponding to the right-side region 15b, the processor 12b can also detect a motion vector of an object moving within the right-half region 15R between frames, and an object moving between the right-half region 15R and the extension region 15e₂.

In other words, according to the configuration of the present embodiment, by causing the regions whose processing is divided between the two processors 12a and 12b to overlap, it is possible to obtain a motion vector for the entire screen even in the case in which an object appearing in the screen moves so as to cross the screen.

Note that although the screen synthesis unit 13 performs processing for generating a video signal corresponding to the full screen based on the processing result of the frame interpolation processing unit 123a (i.e., the interpolated video signal corresponding to the left-side region 15a) and the processing result of the frame interpolation processing unit 123b (i.e., the interpolated video signal corresponding to the right-side region 15b), it is preferable to give consideration to the direction of motion vectors when performing synthesis processing on video signals corresponding to the extension region 15e₁ and the extension region 15e₂, which are regions of overlap between the left-side region 15a and the right-side region 15b. The reason for this is described below.

When detecting a motion vector, it is common to reference not only the results of detecting motion vectors in a video signal between two consecutive frames, but also motion vectors obtained between previous frames. Since normally there is continuity in the movement of an object, giving consideration to the continuity in the movement of the object in three or more frames enables detecting a motion vector more accurately and effectively.

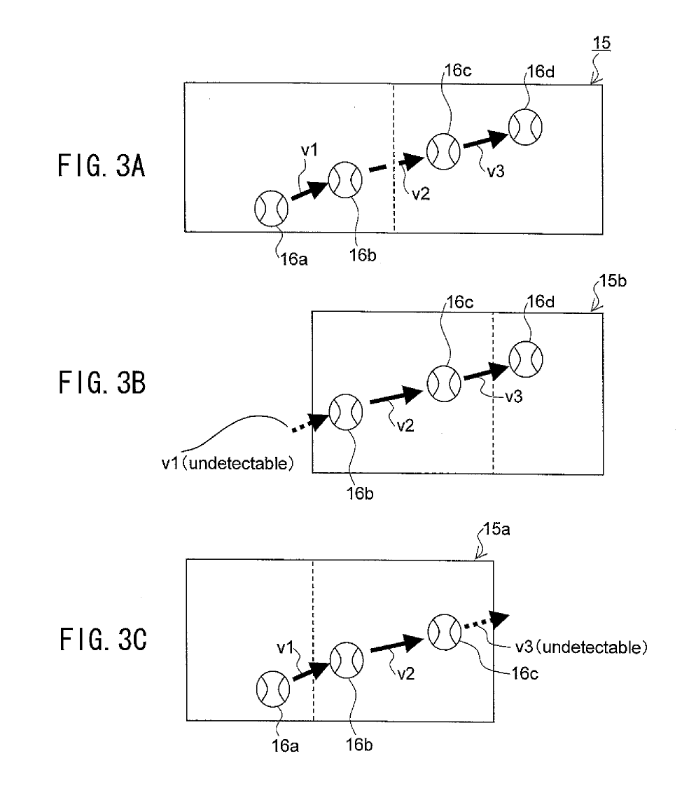

Below is a description taking the exemplary case of detecting a motion vector of the object 16 that moves within the full screen as shown in FIG. 3A. In FIG. 3A, 16a denotes an image of the object 16 in a first frame, 16b denotes an image thereof in a second frame, 16c denotes an image thereof in a third frame, and 16d denotes an image thereof in a fourth frame.

Although a motion vector v1 of the object 16 between the first frame and the second frame originally is detected between the object image 16a and the object image 16b, the object image 16a does not appear in the video signal corresponding to the right-side region 15b as shown in FIG. 3B. Accordingly, the motion vector v1 is not detected by the processor 12b that detects a motion vector based on the video signal corresponding to the right-side region 15b. On the other hand, the object image 16a and the object image 16 both appear in the video signal corresponding to the left-side region 15a as shown in FIG. 3C. Accordingly, the motion vector v1 can be detected based on the object image 16a and the object image 16b by the processor 12a that detects a motion vector based on the video signal corresponding to the left-side region 15a. Information indicating the motion vector v1 is stored in the vector memory 122a of the processor 12a.

Also, a motion vector v2 of the object 16 between the second frame and the third frame is detected based on the object image 16b and the object image 16c, with reference to the motion vector v1. At this time, the object image 16b and the object image 16c appear in the video signal corresponding to the left-side region 15a as shown in FIG. 3C, and information indicating the motion vector v1 is stored in the vector memory 122a as described above. Accordingly, the processor 12a can detect the motion vector v2 accurately. On the other hand, although the object image 16b and the object image 16c appear in the video signal corresponding to the right-side region 15b as shown in FIG. 3B, the processor 12b cannot detect the motion vector v1 as described above, and therefore information indicating the motion vector v1 is not stored in the vector memory 122b of the processor 12b. Accordingly, the processor 12b detects the motion vector v2 from only the object image 16b and the object image 16c, without referencing the motion vector v1, and therefore the accuracy of the detection is lower than that of the detection performed by the processor 12a. In such a case, it is preferable for the screen synthesis unit 13 to use the motion vector v2 detected by the processor 12a rather than the motion vector v2 detected by the processor 12b, when generating interpolated video between the second frame and the third frame.

For this reason, when generating a frame interpolated image in the extension region 15e₁ and the extension region 15e₂, the screen synthesis unit 13 uses the detection result obtained by the processor 12a (i.e., the detection result corresponding to the left-side region 15a) if the horizontal component of the motion vector is right-pointing, and uses the detection result obtained by the processor 12b (i.e., the detection result corresponding to the right-side region 15b) if the horizontal component of the motion vector is left-pointing. This enables accurately generating a frame interpolated image in the extension region 15e₁ and the extension region 15e₂.

Note that in the video signal processing device of the present embodiment, it is sufficient for the sizes of the extension regions 15e₁ and 15e₂ to be set appropriately according to, for example, the processing capacity of the processors 12a and 12b. To give one preferred example, in the case of a full high definition display (1920 pixels horizontal by 1080 pixels vertical), the resolution of the video signal is 1980 pixels horizontal by 1114 pixels vertical, and therefore it is possible for the size of the left-side region 15a to be 1408 pixels in the horizontal direction and the size of the right-side region 15b to be 1408 pixels in the horizontal direction. In this case, the sizes of the extension regions 15e₁ and 15e₂ are each 418 pixels in the horizontal direction.

Also, an exemplary configuration is described in the above embodiment in which the full screen 15 is divided into two regions, namely the left-side region 15a and the right-side region 15b, and the processing of the video signals corresponding to these regions is divided between the processors 12a and 12b. However, the number of regions into which the screen is divided and the division pattern are not limited to the examples described above. For example, although the full screen 15 is divided into two regions with respect to the horizontal direction in the example shown in FIG. 2, it is possible to divide the full screen 15 into two regions with respect to the vertical direction. Also, the sizes of the divided regions do not need to be equal.

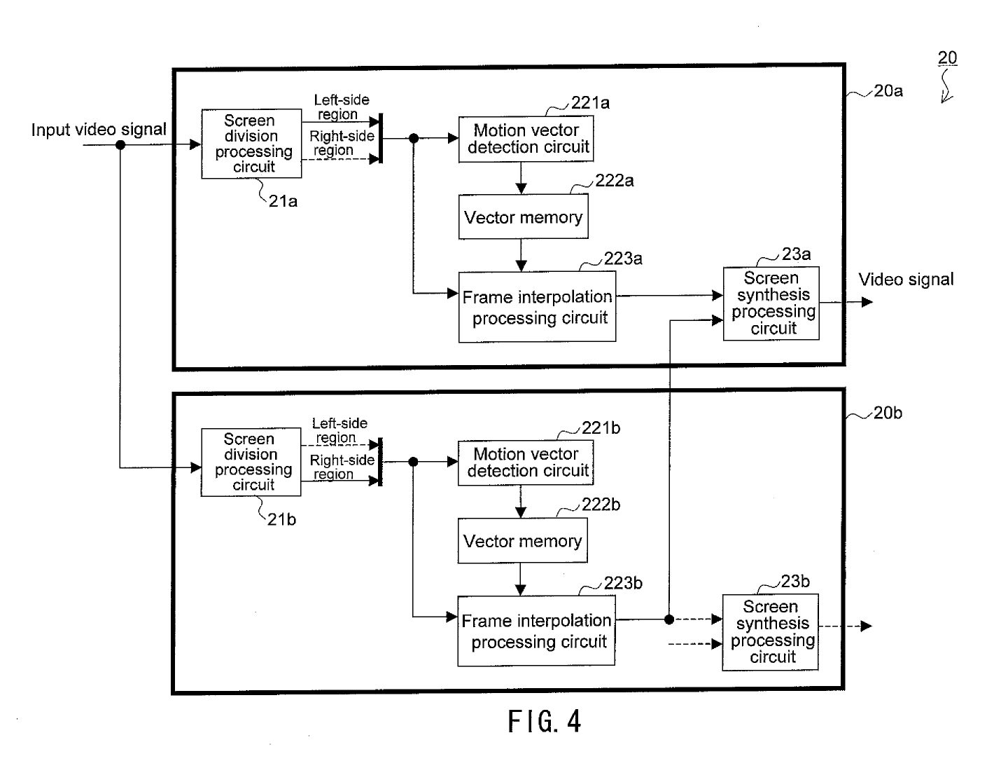

Also, the video signal processing device according to the present embodiment can be implemented by semiconductor chips. In the case where the video signal processing device of the present embodiment is realized with use of a plurality of semiconductor chips each having a processor mounted thereon, it is preferable for the chip design to be common among the chips in consideration of the design cost and manufacturing cost of the semiconductor chips. FIG. 4 shows a concrete example of the case in which the video signal processing device of the present embodiment shown in the functional block diagram of FIG. 1 is configured by two semiconductor chips.

In the example shown in FIG. 4, a video signal processing device 20 is configured by two semiconductor chips 20a and 20b. The semiconductor chip 20a includes a screen division processing circuit 21a, a motion vector detection circuit 221a, a vector memory 222a, a frame interpolation processing circuit 223a, and a screen synthesis processing circuit 23a. The screen division processing circuit 21a, the motion vector detection circuit 221a, the frame interpolation processing circuit 223a, and the screen synthesis processing circuit 23a are circuits that respectively realize the same functionality as that of the screen division unit 11, the motion vector detection unit 121a, the frame interpolation processing unit 123a, and the screen synthesis unit 13 that are shown in the functional block diagram of FIG. 1.

The semiconductor chip 20b includes a screen division processing circuit 21b, a motion vector detection circuit 221b, a vector memory 222b, a frame interpolation processing circuit 223b, and a screen synthesis processing circuit 23b. In the semiconductor chip 20b, the screen division processing circuit 21b, the motion vector detection circuit 221b, the vector memory 222b, the frame interpolation processing circuit 223b, and the screen synthesis processing circuit 23b have exactly the same circuit configurations as the screen division processing circuit 21a, the motion vector detection circuit 221a, the vector memory 222a, the frame interpolation processing circuit 223a, and the screen synthesis processing circuit 23a of the semiconductor chip 20a. In other words, using chips that have a common basic layout as the semiconductor chips 20a and 20b enables reduction in the design cost and manufacturing cost of the chips, and providing the video signal processing device 20 at low cost.

Note that in the semiconductor chip 20a, the screen division processing circuit 21a is connected to the motion vector detection circuit 221a and the frame interpolation processing circuit 223a only by an output line for the video signal corresponding to the left-side region, and an output line for the video signal corresponding to the right-side region is disconnected. On the other hand, in the semiconductor chip 20b, the screen division processing circuit 21b is connected to the motion vector detection circuit 221b and the frame interpolation processing circuit 223b only by an output line for the video signal corresponding to the right-side region, and an output line for the video signal corresponding to the left-side region is disconnected. Furthermore, in the semiconductor chip 20b, the output line from the frame interpolation processing circuit 223b to the screen synthesis processing circuit 23b is disconnected, and wiring is formed from an output terminal of the frame interpolation processing circuit 223b to an input terminal of the screen synthesis processing circuit 23a of the semiconductor chip 20a. In other words, the screen synthesis processing circuit 23b does not function in the semiconductor chip 20b.

Note that FIG. 4 shows an exemplary configuration in which a plurality of semiconductor chips having the same layout are used to achieve the use of a common chip layout in view of reducing the design cost and manufacturing cost. However, the implementation of the video signal processing device according to the present invention is not limited to this example. For example, the screen division unit 11, the processor 12a, the processor 12b, and the screen synthesis unit 13 that are shown in FIG. 1 may be configured by each being implemented by a semiconductor chip. In other words, how the units are implemented on semiconductor chips is arbitrary design matter.

### Embodiment 2

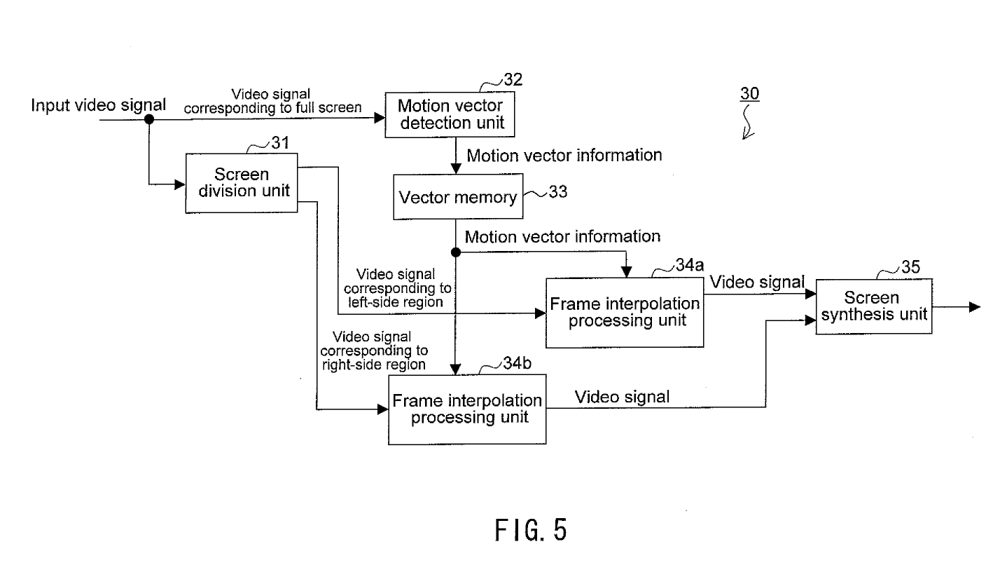

Below is a description of a video signal processing device according to Embodiment 2 of the present invention with reference to FIGS. 5 to 7.

FIG. 5 is a block diagram showing the schematic configuration of the video signal processing device according to the present embodiment. As shown in FIG. 5, a video signal processing device 30 according to the present embodiment includes a screen division unit 31, a motion vector detection unit 32, a vector memory 33, frame interpolation processing units 34a and 34b, and a screen synthesis unit 35.

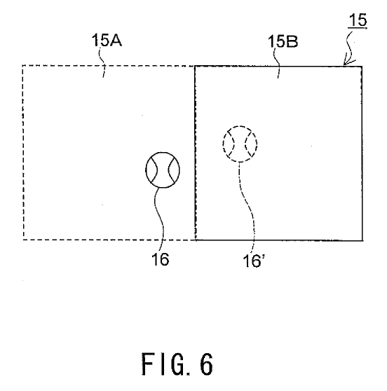

Unlike the screen division unit 11 shown in FIG. 1 in Embodiment 1, the screen division unit 31 divides an input video signal into a left-side region 15A and a right-side region 15B without any overlapping (see FIG. 6), and outputs video signals corresponding to the regions to the frame interpolation processing units 34a and 34b. The motion vector detection unit 32 has a frame memory (not shown) that stores at least two frames of the input video signal, and detects a motion vector between consecutive frames by dividing the input video signal into blocks of a predetermined size and performing block matching between frames. A detailed description of the method for detecting motion vectors has been omitted since such methods are well-known. Note that besides block matching, motion vectors may be detected by pixel matching. Also, although a configuration in which motion vectors are detected separately with respect to the left-side region 15a and the right-side region 15b is described in Embodiment 1, the motion vector detection unit 32 of the present embodiment differs from Embodiment 1 in that a motion vector is detected from the input video signal (i.e., the video signal corresponding to the full screen). Information indicating the motion vector detected by the motion vector detection unit 32 is stored in the vector memory 33.

The frame interpolation processing unit 34a generates a frame interpolated image corresponding to the left-side region 15A based on the motion vector information stored in the vector memory 33 and the video signal corresponding to the left-side region 15A that has been obtained from the screen division unit 31. The frame interpolation processing unit 34b generates a frame interpolated image corresponding to the right-side region 15B based on the motion vector information stored in the vector memory 33 and the video signal corresponding to the right-side region 15B that has been obtained from the screen division unit 31.

The screen synthesis unit 35 generates and outputs a video signal corresponding to the full screen by synthesizing the frame interpolated image corresponding to the left-side region 15A that was generated by the frame interpolation processing unit 34a and the frame interpolated image corresponding to the right-side region 15B that was generated by the frame interpolation processing unit 34b.

According to the video signal processing device 30 of the present embodiment, a motion vector is detected based on the video signal corresponding to the full screen, thereby enabling accurate detection of motion vectors. Specifically, in the case of detecting a motion vector based on the video signals corresponding to the left-side region 15a and the right-side region 15b as shown in FIGS. 3B and 3C in Embodiment 1, a motion vector cannot be detected for the object that moves so as to cross the boundary line at the edges of the regions. In contrast, the present embodiment enables detecting a motion vector with respect to the entire screen.

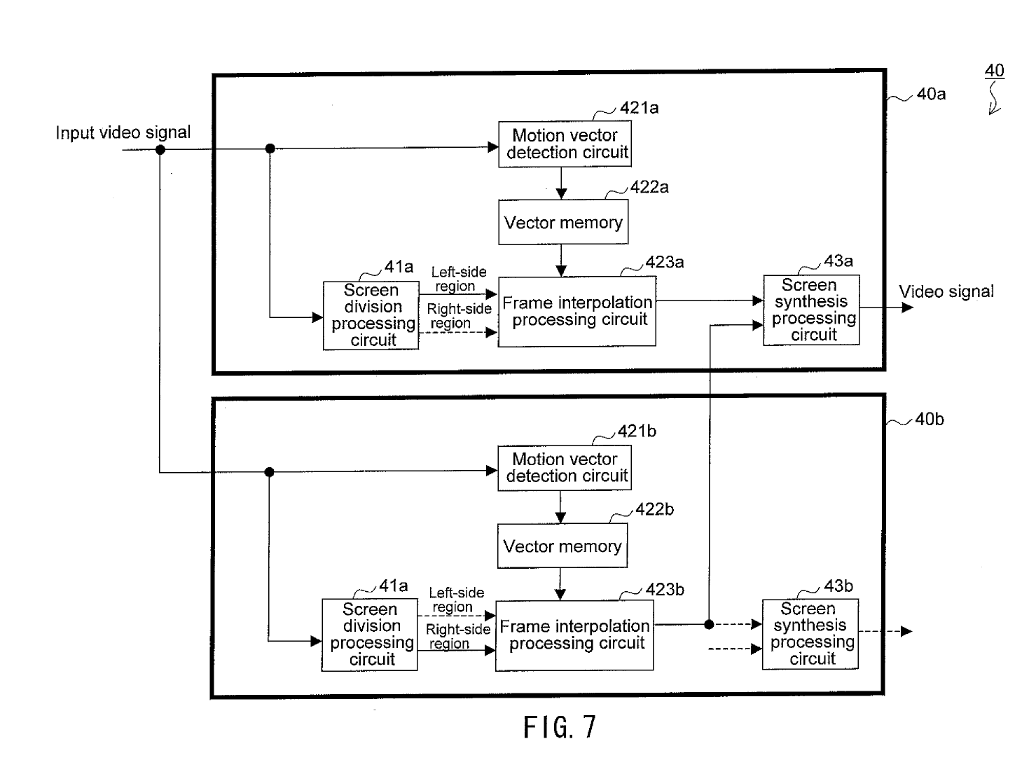

Also, FIG. 7 shows a concrete example of the case in which the video signal processing device of the present embodiment shown in the functional block diagram of FIG. 5 is configured by two semiconductor chips.

In the example shown in FIG. 7, a video signal processing device 40 is configured by two semiconductor chips 40a and 40b. The semiconductor chip 40a includes a screen division processing circuit 41a, a motion vector detection circuit 421a, a vector memory 422a, a frame interpolation processing circuit 423a, and a screen synthesis processing circuit 43a. The screen division processing circuit 41a, the motion vector detection circuit 421a, the frame interpolation processing circuit 423a, and the screen synthesis processing circuit 43a are circuits that respectively realize the same functionality as that of the screen division unit 31, the motion vector detection unit 32, the frame interpolation processing unit 34a, and the screen synthesis unit 35 that are shown in the functional block diagram of FIG. 5.

The semiconductor chip 40b includes a screen division processing circuit 41b, a motion vector detection circuit 421b, a vector memory 422b, a frame interpolation processing circuit 423b, and a screen synthesis processing circuit 43b. In the semiconductor chip 40b, the screen division processing circuit 41b, the motion vector detection circuit 421b, the vector memory 422b, the frame interpolation processing circuit 423b, and the screen synthesis processing circuit 43b have exactly the same circuit configurations as the screen division processing circuit 41a, the motion vector detection circuit 421a, the vector memory 422a, the frame interpolation processing circuit 423a, and the screen synthesis processing circuit 43a of the semiconductor chip 40a. In other words, using chips that have a common basic layout as the semiconductor chips 40a and 40b enables reduction in the design cost and manufacturing cost of the chips, and providing the video signal processing device 40 at low cost.

Note that in the semiconductor chip 40a, the screen division processing circuit 41a is connected to the frame interpolation processing circuit 423a only by an output line for the video signal corresponding to the left-side region, and an output line for the video signal corresponding to the right-side region is disconnected. On the other hand, in the semiconductor chip 40b, the screen division processing circuit 41b is connected to the frame interpolation processing circuit 423b only by an output line for the video signal corresponding to the right-side region, and an output line for the video signal corresponding to the left-side region is disconnected. Furthermore, in the semiconductor chip 40b, the output line from the frame interpolation processing circuit 423b to the screen synthesis processing circuit 43b is disconnected, and wiring is formed from an output terminal of the frame interpolation processing circuit 423b to an input terminal of the screen synthesis processing circuit 43a of the semiconductor chip 40a. In other words, the screen synthesis processing circuit 43b does not function in the semiconductor chip 40b. Also, in the semiconductor chips 40a and 40b, the video signal corresponding to the full screen is input to the motion vector detection circuits 421a and 421b, and motion vector detection is performed with respect to the video signal corresponding to the full screen in both of the semiconductor chips 40a and 40b.

Note that FIG. 7 shows an exemplary configuration in which a plurality of semiconductor chips having the same layout are used to achieve the use of a common chip layout in view of reducing the design cost and manufacturing cost. However, the implementation of the video signal processing device according to the present invention is not limited to this example. For example, how the units shown in FIG. 5 are implemented on semiconductor chips is arbitrary design matter.

Furthermore, although a video signal processing device that detects a motion vector and performs frame interpolation with use of the detected motion vector is described as an example in Embodiments 1 and 2 above, the present invention is also applicable to devices that perform video signal processing other than frame interpolation processing. In other words, the present invention enables accurate detection of a vector between images with use of a plurality of processors, and therefore the present invention is applicable to video signal processing devices that make use of the detected vector in processing other than frame interpolation processing, such as noise reduction processing, processing for conversion of a signal from interlace to progressive, and scaling processing.

### INDUSTRIAL APPLICABILITY

The present invention is industrially applicable as a video signal processing device that can detect motion vectors accurately.

1. A video signal processing device comprising:
a motion vector detection unit that detects a motion vector from an input video signal;
a vector memory that stores information indicating the motion vector detected by the motion vector detection unit;
a plurality of signal processing units that each process a video signal, the input video signal being divided into n (n being an integer greater than or equal to 2) regions, and processing of video signals corresponding to the regions being divided among the plurality of signal processing units and performed with use of the motion vector information stored in the vector memory; and
a synthesis processing unit that generates an output video signal by synthesizing processing results of the plurality of signal processing units,
wherein the motion vector detection unit detects a motion vector with respect to regions that include regions obtained by evenly dividing the input video signal into n regions, and are larger than the obtained regions.

2. The video signal processing device according to claim 1, wherein the motion vector detection unit includes a first motion vector detection unit that detects a motion vector with respect to one of two regions that each have an overlapping part in a horizontal or vertical center portion of the input video signal, and a second motion vector detection unit that detects a motion vector with respect to the other of the two regions.

3. The video signal processing device according to claim 2, wherein in generating an output video signal corresponding to the overlapping parts of the two regions in the input video signal, the synthesis processing unit determines which of the processing results of the plurality of signal processing units is to be used, according to a pointing direction of a horizontal or vertical component of the motion vector.

4. The video signal processing device according to claim 1, wherein the motion vector detection unit detects a motion vector with respect to the entirety of the input video signal.
